(19) United States
(12) Patent Application Publication
(10) Pub. No.: US 2023/0024423 A1
(43) Pub. Date: Jan. 26, 2023

(54) Multi-Layer Insulator for Thermal Run-Away Containment in Lithium-Ion Batteries

(71) Applicant: Lydall Thermal/Acoustical, Inc., Hamptonville, NC (US)

(72) Inventor: Brian Matthew JARRARD, Thurmond, NC (US)

(21) Appl. No.: 17/871,424

(22) Filed: Jul. 22, 2022

Related U.S. Application Data
(60) Provisional application No. 63/224,945, filed on Jul. 23, 2021.

(51) Int. Cl. B32B 5/06; H01M 10/658; B32B 5/02; B32B 5/26; B32B 7/09

(52) U.S. Cl. CPC B32B 5/073; H01M 10/658; B32B 5/024; B32B 5/026; B32B 5/262; B32B 7/09; H01M 10/0525

(57) ABSTRACT

A multi-layered composite insulation material includes a first and second outer layers having one or more of para-aramid, meta-aramid, flame-retarded modacrylic, or pre-oxidized polyacrylonitrile fibers; and an inner layer disposed between the first and second outer layers having one or more of polyacrylonitrile fibers or ceramic fibers. The inner and outer layers are bonded via needle punching, thermal bonding, or stitch bonding. The outer layers further include flame-retardant rayon fibers and a woven or knit fabric having continuous high-temperature glass, silica, or ceramic filaments.

### BACKGROUND AND SUMMARY OF THE INVENTION

Lithium-ion batteries may be utilized in battery-powered electric vehicles (BEVs) or plug-in hybrid electric vehicles (PHEVs) for their many advantages, such as high energy density, low mass, long life, and sealed cell design. At the same time, lithium-ion batteries may be vulnerable to volatile thermal runaway events when damaged, such as in the case of a physical impact or internal malfunction.

Thermal runaway may be understood as when the temperature of a lithium-ion cell is raised to the point where the cell materials begin an exothermic decomposition process. The decomposition releases heat in a self-perpetuating manner more quickly than it can dissipate, leading to rapid “runaway” in temperature of the battery cells, reaching more than 1000° Celsius. In some cases, thermal runaway of one battery cell may cause adjacent battery cells to successively begin decomposing and undergo corresponding temperature increases such that the entire vehicle battery pack is consumed by the thermal runaway event.

This present subject matter is directed to a multi-layered composite designed to meet specific mechanical and thermal goals for risk management of thermal runaway events occurring in a vehicle. More specifically, these events may be experienced in battery-powered BEVs or PHEVs, which may employ a lithium-ion-based battery pack. When punctured or overheated during a collision or other catastrophic event, the lithium-ion battery cells may release energy in an extremely volatile fashion. The multi-layer insulation disclosed in accordance with the present subject matter may slow the thermal runaway event, thereby increasing the amount of time for first responders to move victims of a collision to a safe distance and/or protect adjacent structures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a close-up view of an example multi-layered composite according to an embodiment of the present subject matter; and

FIG. 2 shows an example method of producing the multi-layered composite according to an embodiment of the present subject matter.

### DETAILED DESCRIPTION OF THE DRAWINGS

The disclosed multi-layered composite may provide a durable insulation solution designed to slow thermal runaway events that occur due to malfunction or damage to vehicle battery modules. Specifically, the multi-layered composite may inhibit the transfer of heat and explosive debris projected by one battery module from reaching an adjacent battery module. By slowing the thermal runaway event, the multi-layered composite may provide additional time for the vehicle occupants to reach safety.

According to an embodiment of the present subject matter, a multi-layered composite insulation material includes a first and second outer layers comprising one or more of: para-aramid, meta-aramid, flame-retarded modacrylic, or pre-oxidized polyacrylonitrile fibers. The material further includes an inner layer disposed between the first and second outer layers comprising one or more of: polyacrylonitrile fibers or ceramic fibers, wherein the inner and outer layers are bonded.

According to an embodiment of the present subject matter, a multi-layered composite insulation material includes a first and second outer layers comprising one or more of: para-aramid, meta-aramid, flame-retarded modacrylic, or pre-oxidized polyacrylonitrile fibers. The material further includes an inner layer disposed between the first and second outer layers comprising one or more of: polyacrylonitrile fibers or ceramic fibers. The inner and outer layers are bonded via needle punching, thermal bonding, or stitch bonding. The inner and outer layers further include flame-retardant rayon fibers. The inner and outer layers further include a woven or knit fabric comprising continuous high-temperature glass, silica, or ceramic filaments.

According to an embodiment of the present subject matter, a multi-layered composite insulation material includes a first layer comprising one or more of: para-aramid, meta-aramid, flame-retarded modacrylic, or pre-oxidized polyacrylonitrile fibers. The material further includes a second layer comprising one or more of: polyacrylonitrile fibers or ceramic fibers. The first and second layers are bonded via needle punching, thermal bonding, or stitch bonding.

The following description is merely exemplary in nature and is in no way intended to limit the present disclosure or the application or use thereof.

For the purpose of this disclosure, the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one source”, “one or more sources”, and “source(s)” may be used interchangeably and are intended to have the same meaning.

The recitations of numerical ranges by endpoints include the endpoints and all numbers within that numerical range. For example, a concentration ranging from 40% by volume to 60% by volume includes concentrations of 40% by volume, 60% by volume, and all concentrations there between (e.g., 40.1%, 41%, 45%, 50%, 52.5%, 55%, 59%, etc.).

For purposes of promoting an understanding of the principles of the present disclosure, reference will now be made to the embodiments illustrated in the drawings, and specific language will be used to describe the same. It should be understood that throughout the description, corresponding reference numerals indicate like or corresponding parts and features. One skilled in the art will further understand that any properties reported herein represent properties that are routinely measured and may be obtained by multiple different methods. The methods described herein represent one such method and other methods may be utilized without exceeding the scope of the present disclosure.

No limitation of the scope of the present disclosure is intended by the illustration and description of certain embodiments herein. In addition, any alterations and/or modifications of the illustrated and/or described embodiment(s) are contemplated as being within the scope of the present disclosure. Further, any other applications of the principles of the present disclosure, as illustrated and/or described herein, as would normally occur to one skilled in the art to which the disclosure pertains, are contemplated as being within the scope thereof.

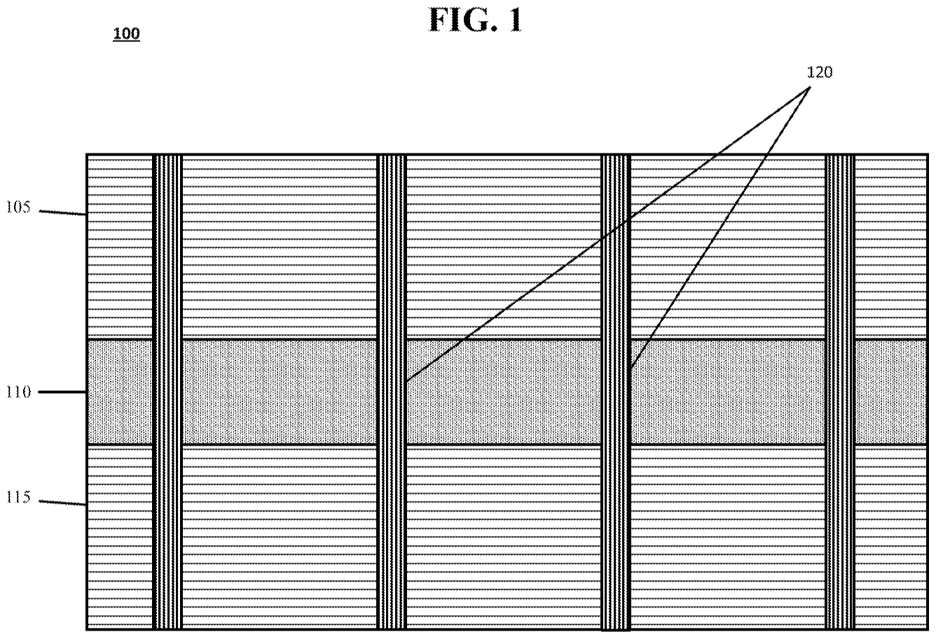

FIG. 1 shows an example of a multi-layered composite insulation product 100 that may include at least two, but preferably, three layers 105/110/115. The outer layers 105/115 may provide mechanical toughness, abrasion resistance, and high dielectric strength. The inner flame barrier layer 110 may provide a permanent flame barrier that can resist no less than a 1200° Celsius flame for at least ten minutes, which conforms with the ISO 6469 standard for BEVs and PHEVs. The outer layers 105/115, which may be inherently flame retardant, may not provide an adequate flame barrier for the long term, high-temperature exposure that may occur during a thermal runaway event. Alternatively, or in addition, one or more of the outer layers 105/115 may incorporate materials or reinforcing components capable of withstanding explosive forces and debris without rupture, such as a woven or knit fabric composed from continuous high-temperature filaments, such as glass, silica, or ceramic fibers. Outer layer 115, for example, may also incorporate flame-retardant rayon fibers, which may be blended with the other fibers of outer layer 115 in a proportion of about 30% to 70% by weight, to form a heavier char layer during a thermal runaway event. The dielectric strength of outer layers 105/115 may be greater than 25 volts per mil, preferably greater than 50 volts per mil, where 1 mil equals 1/1000^{th} of an inch. The dielectric strength may be specific to a vehicle based on operating environment factors, such as the powertrain operating voltage.

As previously mentioned, a two-layer embodiment of the multi-layered composite insulation product 100 may also contemplated within the scope of the present subject matter. The two-layer embodiment may include only outer layer 105 and inner flame barrier layer 110, for example. In this example, the outer layer 105 may be placed directly opposite the vehicle electrical components, such as a battery cell or battery pack, while the inner flame barrier layer 110 may be placed directly opposite the vehicle body structure or other components or surfaces for which protection is desired. It should be appreciated that the inner flame barrier layer 110 may be less resistant to physical stresses, which may limit the areas in which the two-layer insulation product 100 may be suitably disposed within the vehicle.

In an embodiment, the outer layers 105/115 may be formed from a blend comprising one or more of para-aramid, meta-aramid, and/or flame-retardant modacrylic fibers. In the case where ceramic fibers are used alone or blended to form inner flame barrier layer 110, pre-oxidized polyacrylonitrile (PAN) fibers may also be used alone or blended with the aforementioned fiber types to form outer layers 105/115. The para-aramid and/or meta-aramid fibers may range from about 1.2 denier to 3.0 denier, while the flame-retardant modacrylic fibers may range from about 2 to 7 denier. The proportion of para-aramid fibers may range from about 10 to 30% of the total layer by weight. The proportion of meta-aramid fibers may range from about 30 to 70% of the total layer by weight. The proportion of flame-retardant modacrylic fibers may range from about 0 to 40% of the total layer by weight, depending upon the application. When ceramic fibers are used to form the inner flame barrier layer 110, as previously described, the proportion of pre-oxidized PAN fibers in outer layers 105/1105 may range from about 30% to 100% by weight. The weight of each outer layer 105/115 may range between about 50 grams per square meter (gsm) to 240 gsm, but more preferably about 80 gsm to 120 gsm, depending on application requirements and the desired thickness of the layer. In an embodiment, the outer layers 105/115 may range in thickness between about 0.1 mm to 3.5 mm, preferably about 0.25 mm to 2.5 mm.

Inner flame barrier layer 110 may be preferably formed from PAN fibers or ceramic fibers having a weight between about 200 gsm and 1000 gsm. The inner flame barrier layer 110 may range in thickness between about 0.5 mm to 7.5 mm, preferably 1 mm to 6 mm. In addition to PAN fibers, other types of fibers composed of polyphenylene sulfide (PPS), fiberglass, silica, ceramic, flame-retardant rayon, or other flame-retardant modacrylic fibers, or a blend from any two or more types of fibers may be substituted without departing from the scope of the present subject matter.

Importantly, the outer layers 105/115 and inner flame barrier layer 110 should be combined in a manner that does not introduce flammable materials. For instance, a flammable adhesive may not be appropriate to laminate the outer layers 105/115 and inner flame barrier layer 110 together, since this may contribute to the potential thermal energy of a thermal runaway event. Additionally, because the multi-layered composite insulation product 100 may be used in a vehicle proximate to its occupants, few, preferably none of the fibrous materials should be respirable or irritating to humans. The multi-layered composite insulation product 100 may also be free of the intumescent coatings used in other fireproofing applications.

Needle punching may be one acceptable manner of combining the layers 105/110/115 that does not increase the flammability of the composite. Alternatively, or in addition, the layers 105/110/115 may be stitch-bonded together using a glass-based sewing thread. Needle punching the layers 105/110/115 may increase the binding strength and overall material strength by mechanically entangling the fibers of each of layers 105/110/115 in the regions of the material proximate to each punch 120. FIG. 1 shows an example of needled punches 120 to bind the layers 105/110/115 together so that the layers 105/110/115 are substantially non-detachable from each other, thereby forming an integral composite fabric. Thermal bonding of the layers 105/110/115 may also be used and could be achieved using non-flammable resins or binders. For instance, non-flammable binding agents such as Acrodur®, epoxy, and phenolic resins may be used to bind the layers 105/110/115 without reducing flame-blocking performance of the multi-layered composite insulation product 100.

The multi-layered composite insulation product 100 disclosed in accordance with the present subject matter may be useful as an insulating material and may be installed in applications requiring fire protection layers to protect system components and/or personnel from potentially high heat and/or fire. Due to the durability provided by its outer layers 105/115, the disclosed multi-layered composite insulation product 100 may also be useful in applications where an insulating material may be routinely subject to physical stresses, strain, abrasion, compression, impacts, bending, liquid saturation, frequent movement, vibration, impingement, and the like. These stresses may be applied to the insulating material both during normal use and during a thermal runaway failure event. The improved physical strength of the disclosed multi-layered composite insulation product 100 may include enhanced protection against fire when exposed to high-velocity gases and high temperature conditions such as those produced during a thermal runaway event of a rechargeable energy storage system, for example.

The multi-layered composite insulation product 100 disclosed in accordance with the present subject matter may be especially applicable to batteries or other charge storage devices used in BEVs and PHEVs. For instance, the disclosed multi-layered composite insulation product 100 may be resistant to electrical conduction via its dielectric properties, which may be advantageous when installed near high-voltage or high-current electrical systems. The disclosed multi-layered composite insulation product 100 may be installed near electrical wiring, bus bars, batteries, connectors, fuse and breaker panels, transformers, and the like, without risk of short circuit or electrical arcing. In some embodiments, the disclosed multi-layered composite insulation product 100 may be used in a battery compartment of a vehicle. The disclosed multi-layered composite insulation product 100, which may be manufactured in both flexible and stiffened formats alike, may be used as an enclosure for one or more battery modules or battery packs of a vehicle.

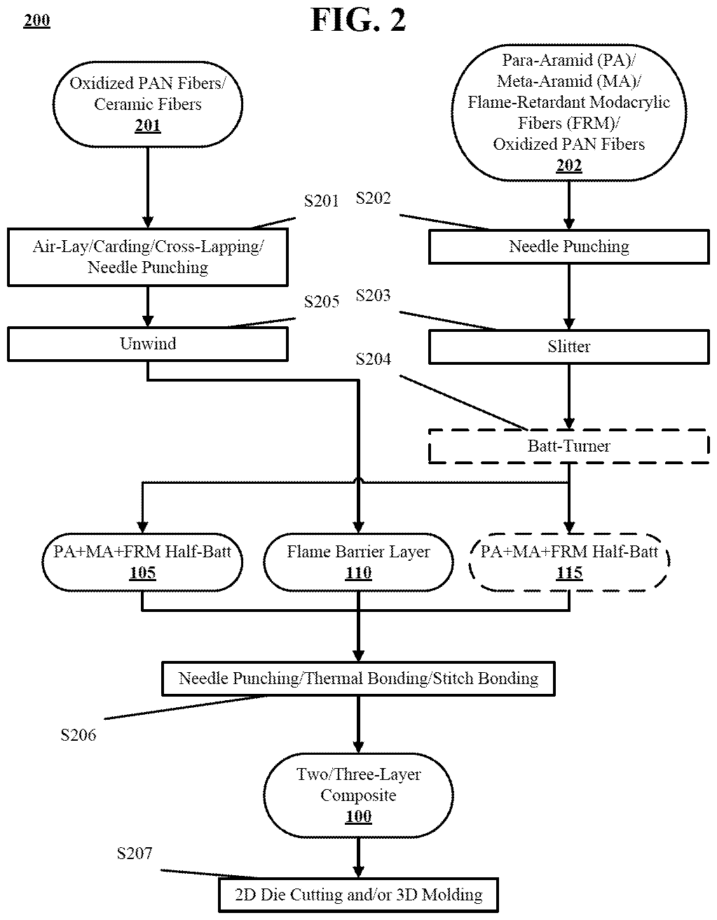

An example method 200 of producing the multi-layered composite insulation product 100 is shown in FIG. 2. In this example, the multi-layered composite insulation product 100 may be composed of two outer layers 105/115 and a single inner flame barrier layer 110, but an analogous process applies for the two-layer product previously described. The outer layers 105/115 may each be composed of a blend 202 of two or more of para-aramid, meta-aramid, or flame-retardant modacrylic fibers. The inner flame barrier layer 110 may be composed of oxidized PAN fibers 201 or ceramic fibers. Alternatively, or in addition, where ceramic fibers are used to form the inner flame barrier layer 110, oxidized PAN fibers may be used alone or blended with other fibers of the outer layer(s) 105/115. In S201, the oxidized PAN fibers that will form the inner flame barrier layer 110 may be air-laid, carded, cross-lapped, and/or needled punched. On a second needle punch line, the fiber blend 202 may be needle punched together in S202 to create a felt. The felt may then pass through a slitter in S203 to create two half-batts that will form outer layers 105/115. The two felt half-batts 105/115 may then optionally, but preferably be provided to a batt-turner in S204 that turns the batts 105/115 around a 90° corner such that the two felt half-batts 105/115 may be disposed on top of one another. At this point, the oxidized pan fibers 201, which have been air-laid, carded, cross-lapped, and/or needle punched in S201, may be unwound as the flame barrier (inner layer) 110 between the two felt half-bats 105/115 in S205. Each of the half-batts 105/115 and inner flame barrier layer 110 may be needle punched, thermal bonded, or stitched bonded as previously described in S206 to create the multi-layered composite insulation product 100. Based on the desired application, the multi-layered composite insulation product 100 may be further treated, for example, by two-dimensional die cutting and/or three-dimensional molding processes in S207.

The finalized multi-layered composite insulation product 100 may include at least two or three layers, including one or two outer layers 105/115 and an inner flame barrier layer 110 disposed therebetween. In general, the outer layers may provide resistance to physical stresses, while the inner layer may provide fireproofing capability. Thus, the multi-layered composite insulation product 100 may be useful as a fire and heat-blocking material during a potential thermal runaway event of a battery pack.

It should be appreciated that the proportions of para-aramid, meta-aramid, and/or flame-retardant modacrylic fibers, as well as the fiber weights may be adjusted, depending on the desired performance characteristics of the multi-layered composite insulation product 100. For example, to increase the abrasion resistance of the multi-layered composite insulation product 100, the proportion of para-aramid fibers in one or more of the outer layers 105/115 may be increased. If the multi-layered composite insulation product 100 should preferably form a heavier char layer during a thermal runaway event, then the proportion of flame-retardant modacrylic fibers may be increased in one or more of the outer layers 105/115, preferably at least in the outer layer facing opposite the battery module.

The oxidized PAN fibers that form inner flame barrier layer 110 may also be substituted with other types of fibers having similar properties without departing from the scope of the present subject matter. In an example, the oxidized PAN fibers 201 may be substituted with another fire-blocking fibrous material, such as fibers composed of polyphenylene sulfide (PPS), fiberglass, silica, ceramic, flame-retardant rayon, or other flame-retardant modacrylic fibers, or a blend from any two or more types of fibers. In general, a suitable fiber material replacement for the oxidized PAN fibers 201 should preferably exhibit stability when exposed to open-flame temperatures of about 1200° Celsius or greater for at least ten minutes in accordance with ISO 6469.

The processes employed to form the previously-discussed nonwoven inner flame barrier layer 110 may include carding, cross-lapping, and needle punching. The fiber bonding processes may include hydroentangling, calendering, compressive belt thermal bonding, stitch bonding, and the like. Alternatively, or in addition, the inner flame barrier layer 110 may also be produced as a woven, rather than nonwoven material. In that case, a woven textile manufacturing process may be employed where oxidized PAN fibers 201 may be processed by weaving or knitting. A woven inner flame barrier layer 110 may provide increased tensile strength in the machine and cross machine directions due to continuous yarns used in the base fabric but at a greater material cost.

Flammability performance of an insulation material may be measured using horizontal burn tests, such as the FMVSS302/SAE J369 test, or a vertical burn test such as the UL94 test. The multi-layered composite insulation product 100 of the present subject matter may achieve the highest level of performance in these tests resulting in a “does not ignite” rating when tested using the horizontal burn tests and a “V0” rating when tested using the vertical burn tests.

In addition to the noncombustible performance of the disclosed multi-layered composite insulation product 100, the multi-layered composite insulation product 100 may also provide a flame barrier to nearby components or systems that need protection from high-temperature conditions, such as fire. During exposure to open flames, the multi-layered composite insulation product 100 may predominantly remain intact and create a fire-blocking insulation layer, which may prevent fire and high temperatures from propagating to the vulnerable subject(s) to be protected. This high degree of fire-blocking performance when combined with the outstanding physical properties makes the disclosed multi-layered composite insulation product 100 ideal for applications where insulation may be needed to protect the vulnerable subject(s) from fire while also withstanding physical stresses that occur during normal, everyday use, such as compression, bending, impacts, liquid saturation, movement, impingement, and vibration. Additionally, the disclosed multi-layered composite insulation product 100 meets or exceeds the performance of prior art fire-protective materials, such as metal enclosures, with a substantial savings in weight. Potential applications for the disclosed multi-layered composite insulation product 100 may include rechargeable energy store systems, automotive applications, electrical generators, and the like, wherever protection from fire and material durability may be desired.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

The logic illustrated in the flow diagrams may include additional, different, or fewer operations than illustrated. The operations illustrated may be performed in an order different than illustrated.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

In addition to the features mentioned in each of the independent aspects enumerated above, some examples may show, alone or in combination, the optional features mentioned in the dependent aspects and/or as disclosed in the description above and shown in the figures.

The subject matter of the disclosure may also relate, among others, to the following aspects:

A first aspect relates to a multi-layered composite insulation material, including a first and second outer layers comprising one or more of para-aramid, meta-aramid, flame-retarded modacrylic, or pre-oxidized polyacrylonitrile fibers; and an inner layer disposed between the first and second outer layers comprising one or more of polyacrylonitrile fibers or ceramic fibers, wherein the inner and outer layers are bonded.

A second aspect relates to the material of aspect 1, wherein one or more of the outer layers further comprises flame-retardant rayon fibers.

A third aspect relates to the material of any preceding aspect, wherein the dielectric strength of one or more of the outer layers is greater than 50 volts per mil.

A fourth aspect relates to the material of any preceding aspect, wherein one or more of the outer layers further comprises a woven or knit fabric comprising continuous high-temperature filaments fibers.

A fifth aspect relates to the material of any preceding aspect, wherein the first or second outer layer includes para-aramid or meta-aramid fibers of about 1.2 to 3.0 denier.

A sixth aspect relates to the material of any preceding aspect, wherein the first or second outer layer includes modacrylic fibers of about 2 to 7 denier.

A seventh aspect relates to the material of any preceding aspect, wherein the first or second outer layer includes para-aramid fibers of about 10 to 30% of the first or second outer layer by weight.

An eighth aspect relates to the material of any preceding aspect, wherein the first or second outer layer includes flame-retardant modacrylic fibers of about 0 to 40% of the total first or second outer layer by weight.

A ninth aspect relates to the material of any preceding aspect, wherein the weight of the first or second outer layer is between about 50 grams per square meter (gsm) and 240 gsm.

A tenth aspect relates to the material of any preceding aspect, wherein the thickness of the first or second outer layer is about 0.1 mm to 3.5 mm.

An eleventh aspect relates to the material of any preceding aspect, wherein the weight of the inner layer is between about 200 gsm and 1000 gsm.

A twelfth aspect relates to the material of any preceding aspect, wherein the thickness of the inner layer is about 0.5 mm to 7.5 mm.

A thirteenth aspect relates to the material of any preceding aspect, wherein the material is free of flammable materials and does not ignite when tested using SAE J369 horizontal and/or UL94 vertical burn tests.

A fourteenth aspect relates to the material of any preceding aspect, wherein the material is free of intumescent coatings.

A fifteenth aspect relates to the material of any preceding aspect, wherein the inner layer exhibits stability when exposed to open-flame temperatures of about 1200° Celsius or greater for at least ten minutes in accordance with ISO 6469.

A sixteenth aspect relates to the material of any preceding aspect, wherein the outer and inner layers are bonded via needle punching.

A seventeenth aspect relates to the material of any preceding aspect, wherein the outer and inner layers are bonded via thermal bonding.

An eighteenth aspect relates to the material of any preceding aspect, wherein the outer and inner layers are bonded via, or stitch bonding.

A nineteenth aspect relates to a multi-layered composite insulation material, comprising a first and second outer layers comprising one or more of para-aramid, meta-aramid, flame-retarded modacrylic, or pre-oxidized polyacrylonitrile fibers; and an inner layer disposed between the first and second outer layers comprising one or more of polyacrylonitrile fibers or ceramic fibers, wherein the inner and outer layers are bonded via needle punching, thermal bonding, or stitch bonding, and the outer layers further comprise flame-retardant rayon fibers; and a woven or knit fabric comprising continuous high-temperature glass, silica, or ceramic filaments.

A twentieth aspect relates to a multi-layered composite insulation material, comprising a first layer comprising one or more of para-aramid, meta-aramid, flame-retarded modacrylic, or pre-oxidized polyacrylonitrile fibers; and a second layer comprising one or more of polyacrylonitrile fibers or ceramic fibers, wherein the first and second layers are bonded via needle punching, thermal bonding, or stitch bonding.

What is claimed is:

1. A multi-layered composite insulation material, comprising:
a first and second outer layers comprising one or more of:
para-aramid, meta-aramid, flame-retarded modacrylic, or pre-oxidized polyacrylonitrile fibers; and
an inner layer disposed between the first and second outer layers comprising one or more of:
polyacrylonitrile fibers or ceramic fibers,
wherein
the inner and outer layers are bonded.

2. The material of claim 1, wherein
one or more of the outer layers further comprises:
flame-retardant rayon fibers.

3. The material of claim 1, wherein
the dielectric strength of one or more of the outer layers is greater than 50 volts per mil.

4. The material of claim 1, wherein one or more of the outer layers further comprises:
a woven or knit fabric comprising continuous high-temperature filaments fibers.

5. The material of claim 1, wherein
the first or second outer layer includes para-aramid or meta-aramid fibers of about 1.2 to 3.0 denier.

6. The material of claim 1, wherein
the first or second outer layer includes modacrylic fibers of about 2 to 7 denier.

7. The material of claim 1, wherein
the first or second outer layer includes para-aramid fibers of about 10 to 30% of the first or second outer layer by weight.

8. The material of claim 1, wherein
the first or second outer layer includes flame-retardant modacrylic fibers of about 0 to 40% of the total first or second outer layer by weight.

9. The material of claim 1, wherein
the weight of the first or second outer layer is between about 50 grams per square meter (gsm) and 240 gsm.

10. The material of claim 1, wherein
the thickness of the first or second outer layer is about 0.1 mm to 3.5 mm.

11. The material of claim 1, wherein
the weight of the inner layer is between about 200 gsm and 1000 gsm.

12. The material of claim 1, wherein
the thickness of the inner layer is about 0.5 mm to 7.5 mm.

13. The material of claim 1, wherein
the material is free of flammable materials and does not ignite when tested using SAE J369 horizontal and/or UL94 vertical burn tests.

14. The material of claim 1, wherein
the material is free of intumescent coatings.

15. The material of claim 1, wherein
the inner layer exhibits stability when exposed to open-flame temperatures of about 1200° Celsius or greater for at least ten minutes in accordance with ISO 6469.

16. The material of claim 1, wherein
the outer and inner layers are bonded via needle punching.

17. The material of claim 1, wherein
the outer and inner layers are bonded via thermal bonding.

18. The material of claim 1, wherein
the outer and inner layers are bonded via, or stitch bonding.

19. A multi-layered composite insulation material, comprising:
a first and second outer layers comprising one or more of:
para-aramid, meta-aramid, flame-retarded modacrylic, or pre-oxidized polyacrylonitrile fibers; and
an inner layer disposed between the first and second outer layers comprising one or more of:
polyacrylonitrile fibers or ceramic fibers,
wherein
the inner and outer layers are bonded via needle punching, thermal bonding, or stitch bonding, and
the outer layers further comprise:
flame-retardant rayon fibers; and
a woven or knit fabric comprising continuous high-temperature glass, silica, or ceramic filaments.

20. A multi-layered composite insulation material, comprising:
a first layer comprising one or more of:
para-aramid, meta-aramid, flame-retarded modacrylic, or pre-oxidized polyacrylonitrile fibers; and
a second layer comprising one or more of:
polyacrylonitrile fibers or ceramic fibers,
wherein
the first and second layers are bonded via needle punching, thermal bonding, or stitch bonding.
